(19) United States
(12) Patent Application Publication
(10) Pub. No.: US 2016/0074817 A1
(43) Pub. Date: Mar. 17, 2016

(54) Halogen Resistant Amides, Polyamides, and Membranes Made From the Same

(71) Applicants: Andrew P. Murphy, Littleton, CO (US); Robert L. Riley, La Jolla, CA (US); Yuliana E. Porras Mendoza, Arvada, CO (US)

(72) Inventors: Andrew P. Murphy, Littleton, CO (US); Robert L. Riley, La Jolla, CA (US); Yuliana E. Porras Mendoza, Arvada, CO (US)

(21) Appl. No.: 14/857,679

(22) Filed: Sep. 17, 2015

Related U.S. Application Data
(63) Continuation-in-part of application No. 13/828,630, filed on Mar. 14, 2013, now abandoned.

(51) Int. Cl. B01D 71/56; B01D 69/02; C08G 69/00

(52) U.S. Cl. CPC B01D 71/56; C08G 69/00; B01D 69/02; B01D 2325/30

(57) ABSTRACT

A halogen resistant polyamide is formed from the reaction product of an amine monomer and an acid chloride monomer wherein the amino group of the starting amine monomer is separated from the aromatic amine ring system by an alkyl group and (i) minimizes halogenation on the amine and (ii) minimizes N-halogenation at a pH range of approximately 7 to approximately 10.5. A membrane is made from the polyamide for use, for example, in a reverse osmosis desalination unit.

### REFERENCE TO RELATED APPLICATION

This application claims the benefit of U.S. application Ser. No. 13/828,630, filed 14 Mar. 2013, which is incorporated herein by reference in its entirety.

### BACKGROUND OF THE INVENTION

1. Field of the Invention

The present invention relates to halogen resistant amide polymeric compositions including chlorine resistant amide polymers and to membranes made from such and to methods of using said polymers and membranes.

2. Description of the Related Art

The desalting membrane of choice worldwide is a polyamide (PA) membrane. PA membranes are made by forming a thin PA film on a finely porous surface such as a polysulfone (PS) support membrane by an interfacial reaction between the reactant pair trimesoyl chloride (TMC) and m-phenylenedimaine (MPD). The following equation illustrates the chemical formation of a PA desalination barrier:

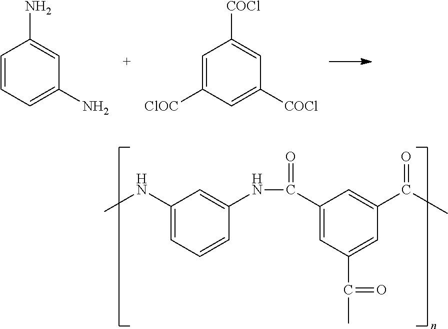

In the above equation, the first term represents m-phenylenediamine in water, the second term represents the trimesoyl chloride in hydrocarbon, and the resultant term represents the fully aromatic polyamide thin film. This is the equation for the PA thin-film composite membrane developed by Cadotte and E. E. Erickson (Desalination, Volume 32, 25-31, 1.980) and, as indicated above, is the membrane in common use throughout the world.

A great need exists to improve the stability of the present state-of-the-art membranes in the presence of chlorine and other oxidants used for disinfection. Such improvement is critical, for example, in reverse osmosis (RO) plants operating on wastewaters, surface waters, and open seawater intakes wherein disinfection by chlorination is required to control the growth of microorganisms (termed biofouling) on the surface of the membrane. These PA membranes are susceptible to deterioration by chlorine that a dechlorination step may be needed when chlorine is used as a disinfectant in the pretreatment. It will be understood that dechlorination prior to the PA membrane creates additional costs and effectively nullifies disinfection on the membrane surface where disinfection is needed. It is also noted that such dechlorination does not neutralize all chlorine, and the small amount of residual chlorine shortens membrane life.

U.S. Pat. No. 7,806,275 (Murphy et al) teaches chlorine resistant polyamides modified with electron-withdrawing groups are useful to make PA membranes, useful in desalination units, that exhibit sufficient activity to minimize any chlorination on both the amine and acid chloride side and minimize N-chlorination and aromatic ring chlorination. The patent states that attempting to add electron-withdrawing groups to the amine side of the membrane can create a number of problems including: (1) difficulties in obtaining precursors and overall synthesis; (2) an increase in electron-withdrawing away from the nitrogen, making such amine monomers less reactive with acid chlorides; (3) resonance problems resulting in ring chlorination on the aromatic ring on the carbonyl side of the amide bond; (4) water solubility problems arising from the addition of hydrophobic groups; and (5) many of the membranes made based on these kinds of amine modifications show problems with flux.

While there are various PA membranes useful for desalination, there still remains a need in the art to improve the chlorine stability of reverse osmosis (RO) membranes. The present invention, different from prior art systems, provides such a membrane that is useful and critical, for example, for desalination in reverse osmosis plants.

### SUMMARY OF THE INVENTION

It is therefore an object of the present invention to provide a halogen resistant polyamide made from the reaction product of an amine monomer and an acid chloride to form a polymer wherein each amino group of the starting amine monomer is separated from the aromatic amine ring by an alkylene group.

Another object of the present invention is to provide a halogen resistant polyamide membrane that is halogen resistant at a pH range of approximately 7 to approximately 10.5, made from the reaction product of an amine monomer and an acid chloride to form a polymer wherein the starting amine monomer is an aromatic amine such as α,α′-dimethyl-1,3-xylylene diamine; α,α,αα,α′-tetramethyl-1,3-xylylene diamine; 1,3,5-tri(aminomethyl) benzene, m-xylylene diamine; o-xylylenediamine; p-xylylenediamine; and mixtures thereof.

With at least one amino group and each amino nitrogen separated from the amine ring system by an alkylene group such as a methylene group for example and the alkylene hydrogens can be replaced with alkyl groups including a methyl group.

A still further object of the present invention is to provide a halogen resistant polyamide membrane made from the reaction product of an amine and an acid chloride to form a polymer that is halogen resistant at a pH range of approximately 7 to approximately 10.5, wherein each amino group of the starting amine monomer is separated from the aromatic amine ring system by an alkylene group, such as for example a methylene group, and said acid chloride is selected from the group consisting oftrimesoyl chloride (TMC), monofluorotrimesoyl chloride (METMC), perfluorotrimesoyl chloride (PFTMC), nitrotrimesoyl chloride (NTMC), perchlorotrimesoyl chloride (PCTMC), 1,3,5-benzenetri-(difluoroacetoyl chloride), isophthaloyl chloride (IPC) and mixtures thereof.

A still further object of the present invention is to provide a halogen resistant polyamide that is halogen resistant at a pH range of approximately 5.5 to approximately 10.5, made from the reaction product of an amine and an acid chloride to form a polymer wherein each amino group on the starting amine monomer is separated from the aromatic amine ring system by an alkylene group such as for example a methylene group and said amine is m-xylylenediamine, o-xylylenediame, p-xylylenediamne, α,α′-dimethyl-1,3-xylylene diamine; α,α,α′,α′-tetramethyl-1,3-xylylene diamine, 1,3,5-tri(aminomethyl) benzene, and mixtures thereof.

Another object of the present invention is to provide a desalination unit having a membrane and a support that includes a halogen resistant polyamide membrane wherein the halogen resistant polyamide membrane is a reaction product of an amine and an acid chloride monomer wherein each amino group of the starting amine monomer is separated from the aromatic amine ring system by an alkylene group such as for example a methylene group and exhibits activity to (i) minimize N-halogenation and ring halogenation at a pH range of approximately 5.5 to approximately 10.5.

A still further object of the present invention is to provide a desalination unit having a membrane support that includes a halogen resistant polyamide membrane wherein the halogen resistant polyamide membrane is a reaction product of an amine and an acid chloride monomer wherein each amino group on the amine monomer is separated from the aromatic amine ring system by an alkylene group such as a methylene group(s) and exhibits activity to (i) minimize N-halogenation and ring halogenation at a pH range of approximately 5.5 to approximately 10.5, wherein said amine of said chlorine resistant membrane is selected from the group consisting of m-xylylenediame, α,α′-dimethyl-1,3-xylylene diamine, α,α,α′,α′-tetramethyl-1,3-xylylene diamine, 1,3,5-tri(aminomethyl) benzene; and mixtures thereof.

A still further object of the present invention is to provide a desalination unit having a membrane and a support that includes a halogen resistant polyamide membrane wherein the halogen resistant polyamide membrane is a reaction produce of an amine and an acid chloride monomer wherein each amino group of the starting amine monomer is separated from the aromatic ring structure of the amine monomer by an alkyl group such as methylene group and exhibits activity to (i) minimize any halogenation on the amine and (ii) minimize N-halogenation at a pH range of approximately 5.5 to approximately 10.5, wherein said acid chloride is selected from the group consisting of trimesoyl chloride (TMC), monofluorotrimesoyl chloride (MFTMC), perfluorotrimesoyl chloride (PFTMC), nitrotrimesoyl chloride (NTMC), perchlorotrimesoyl chloride (PCTMC), 1,3,5-benzenetri-(difluoroacetoyl chloride), isophthaloyl chloride and mixtures thereof.

A still further object of the present invention are compositions providing resistance to halogens, containing a class of amine-based aromatic monomers that have the nitrogen atom on the amino group separated by at least two sigma bonds from the benzene ring system, particularly the monomer meta-tetramethylxylylene diamine (TMMXDA).

Further objects and advantages of the invention will become apparent from the following description.

### BRIEF DESCRIPTION OF THE DRAWINGS

FIG. 1 is a perspective view of a desalination membrane unit.

### DETAILED DESCRIPTION OF THE INVENTION

The present invention is a new approach for producing novel polyamides to use, for example, in producing halogen resistant membranes, especially chlorine resistant membranes, for reverse osmosis and nanofiltration membranes. This invention can also be used to make other plastic items such as, for example, films and tanks. The amides can also be used, for example, by the plastic and rubber industry, paper industry, water and sewage treatment industry, in crayons, pencils, and inks.

Amines, amides, polyamides (linear, cross-linked, low and high molecular weight) described in the present specification, would benefit by these chlorine resistant properties demonstrated in this patent.

The term halogen is used herein to have the same meaning as commonly understood by one of ordinary skill in the art to which the invention belongs and includes fluorine, chlorine, and bromine. The present invention is exemplified and explained using membranes that are chlorine resistant.

The polyamide (PA) spiral-wound thin-film composite membrane elements that are used today are not tolerant to chlorine. The membranes in use today degrade and lack chemical stability when exposed to oxidants such as chlorine. Yet, chlorine is a very effective biocide in water treatment and is desirable. By having a chlorine resistant membrane, desalting plants and mobile desalting units can operate in a more robust fashion, saving costs on membrane cleaning, storage, replacement, and general overall operating expenses.

One aspect of the invention is a chlorine resistant polyamide made from the reaction of an amine monomer and an acid chloride wherein the amine monomer includes amines having an aromatic ring system wherein said ring is 5, 6, or 7 carbons in size. With amines having a ring system, each amino group on a starting amine monomer is modified with an alkylene group such as for example, a methylene group, separating the aromatic amine ring from the amino group. This minimizes N-chlorination and ring chlorination at a pH range of approximately 7 to approximately 10.5. The polyamides of the present invention must be fairly straightforward to synthesize from commercially available precursors to avoid high costs of making the compounds.

Another aspect of the present invention is a chlorine resistant polyamide membrane wherein each amino group of a starting amine monomer is separated from the aromatic amine ring system by an alkylene group, such as for example, a methylene group, which minimizes ring chlorination and minimizes N-chlorination as well at a pH range of approximately 7 to approximately 10.5. Also included in the present invention is an amine monomer having an alkylene group such as for example a methylene group, separating the amino group from the aromatic ring system wherein in the alkyene group hydrogens can be substituted with alkyl groups including for example a methyl group. The addition of an alkylene group between the ring and the amide nitrogen eliminates the substitution effects of groups on the aromatic ring, either electron donating or electron withdrawing, and prevents the lone electron pair on the amide nitrogen form ‘spilling over’ with the pi orbitals of the aromatic ring in the process called resonance, resulting in changes to the chemical reactivity of the amide nitrogen. In the polyamide thin film composite (TFC) membrane, the film is a highly cross-linked polymer in which the amide bonds can be seen from the amine ring with the electronics figured out to favor ortho and para substitution as follows:

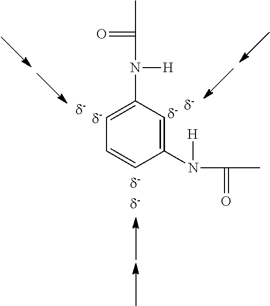

Note the double effect from both groups adding to the reactivity of these sites. Now, due to sterics, the most unlikely site would be ortho to both amide bonds, which leaves the other two sites most likely for attack by chlorine which is confirmed by NMR data below in the examples.

By adding a methylene group to the amine as seen below in the MXD structure:

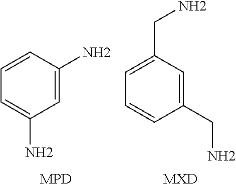

The problem associated with ring chlorination by the above mechanism can be minimized.

The reactivity of the nitrogen on the amide bond below is chemically affected due to resonance:

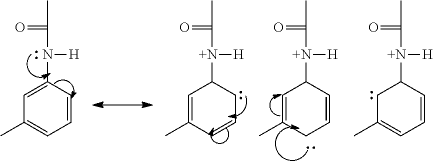

The above shows that the more positive nitrogen would react with hypochlorite ion, the predominate form at pH approximately 8.0 and, because of the electron density shift into the aromatic ring by the lone pair on the nitrogen. Glater et al. (Desalination, Volume 95, 325-345, 1994) shows that ring chlorination follows on the amine ring from an Orton rearrangement which then leads to further polymer/membrane degradation. This would not be the case for above due to the alkylene group separating the ring system from the nitrogen.

These two different principles above give this new approach the advantage of chemical resistance to chlorine degradation.

The following equation is an example of the reaction to make the new polyamides and membranes of the present invention. Note the methylene group between the amino group and the aromatic amine ring:

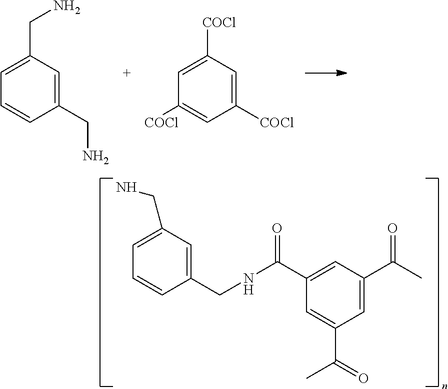

Another aspect is the use of these membranes in a reverse osmosis desalination unit that includes a membrane support, a chlorine resistant membrane supported on the membrane support wherein the chlorine resistant membrane is a reaction product of an amine and an acid chloride wherein the amine of a polyamide is modified with an alkylene group, such as for example a methylene group, separating the amide ring structure from an amino group that minimizes ring chlorination on the amine side and minimizes N-chlorination at a pH range of approximately 7 to approximately 10.5. An additional requirement is that these membranes of the present invention have favorable transport properties, i.e. salt rejection and water flux.

The following acid chloride has been found to be effective for use in synthesizing the chlorine resistant polyamide membrane of the invention:

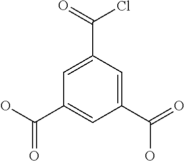 [SMILES: O=C(O)c1cc(C(=O)O)cc(C(=O)Cl)c1]

This compound is trimesoyl chloride (TMC), and is available and used today in the successful TMC-MPD membrane of industry. This is a preferred embodiment of the invention but other acid chlorides could be used too primarily to improve membrane transport properties.

The following amine monomer is an example of an aromatic amine which has been found to be effective for use in synthesizing the chlorine resistant polyamide membrane of the present invention:

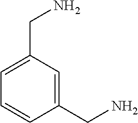

The commercial amine, MPD, has been modified with a methylene group separating the aromatic amine ring from the amino groups. This results in a chlorine resistant polymer at a pH range of approximately 7 to approximately 10.5.

The following membrane is an example of a membrane of the present invention:

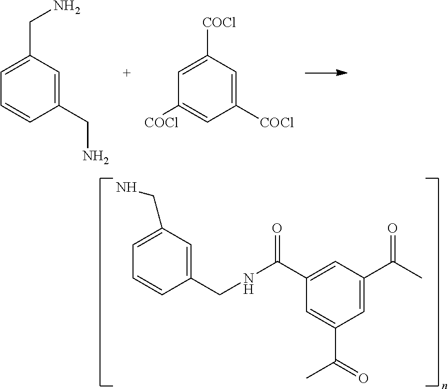

A particular embodiment of aromatic monomers that have the nitrogen atom on the amino group separated by at least two sigma bonds from the benzene ring system, is the novel compound 1,3-tertramethylxylylene diamine for use in halogen resistant compositions and the associated method of making.

The reaction sequence to the 1,3-tertramethylxylylene diamine proceeds via a single step reaction to the di-hydrochloride of the diamine, with high yield, using a readily available precursor. The final product, 1,3-tertramethylxylylene diamine is obtained from deprotonating the di-hydrochloride or “freebasing” from the di-hydrochloride salt. This is a counterintuitive reaction pathway, not obvious to one skilled in the state of the art, because generally the pathway would be to use the amine as the precursor to the isocyanate:

RNH₂+COCl₂→RNCO+2HCl

In our invention, we use the commercially available isocyanate to obtain the diamine. Generally, if this amine was desired, the product would come from the precursor to the corresponding di-isocyanate which in this case would be the readily available, important product of industry, m-TMXDI (see structure below).

On an industrial scale, the most common method of preparing isocyanates involves the reaction of phosgene and the aromatic or aliphatic amine precursors. The formation of the N-substituted carbamoyl chloride is exothermic and followed by the elimination of HCl at elevated temperatures. These reactions are generally:

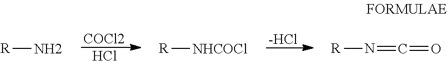

Although there have been serious efforts to develop non-phosgene routes due the “non-green” nature of toxic phosgene, in the case of difunctional aromatic isocyanates the present industrial syntheses use phosgene due to the formation of nonvaluable residual byproducts, insufficient catalyst stability, selectivity, efficiency and recovery that renders any alternative processes economically unacceptable. The industrially important difunctional aromatic isocyanates, TDI and MDI/PMDI are produced using phosgene.

Because of these, it might seem that the amine described herein would exist in the chemical literature and exist as a commercially available precursor to the difunctional aromatic isocyanate, m-TMXDI; however, the industrial synthesis follows a different route. This is because the chemical industry tries to avoid the use of phosgene (COCh) which is hazardous.

The following is the industrial synthesis of m-TMXDI:

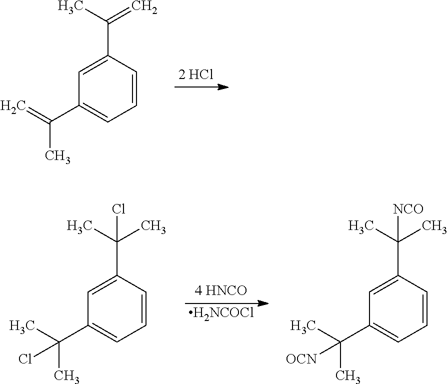

The syntheses to the monomer begins with an acid hydrolysis of an isocyanate:

R(N═C═O)ₓ+HCl_{(excess)}+H₂O_{(excess)}→R(N₃⁺Cl⁻)ₓ+HCl+H₂O+CO₂

Which is followed by deprotonation to the amine:

R(NH₃+Cl⁻)ₓ+OH⁻_{(excess)}+H₂O_{(excess)}→R(NH₂)ₓ+Cl⁻+H₂O

The reaction pathway to the desired 1,3-tetramethylxylylene diamine disclosed herein proceeds as follows with an acid hydrolysis:

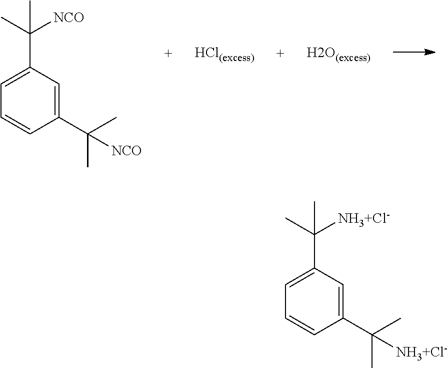

And, the deprotonation to the amine:

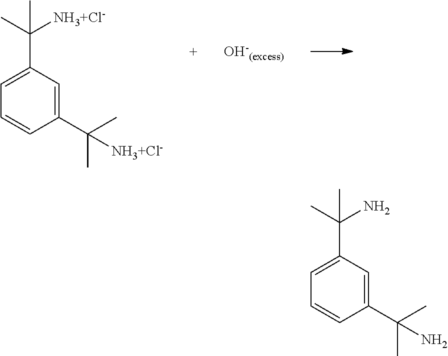

1,3-tetramethylxylylene diamine proceeds as such:
1.) Concentrated HCl was diluted by half to 19%.
2.) 5 g of the diisocyanate was added to a 125 mL flask and 100 mL of 19% HCl.
3.) A magnetic stir bar was added and the reaction heated to just below boiling with rapid stirring for a period of 18 hrs.

After cooling the reaction solution is an ice bath for several hours, a significant volume of white crystals was noted which suggested the salt of the diamine. These crystals were filtered, washed, and dried. These were dissolved in water, adjusted to pH 12, and extracted into the dimethyl carbonate. After rotovap, the final product was obtained.

A crosslinked polyamide of the 1,3-tetramethylxylylene diamine monomer and TMC is shown below:

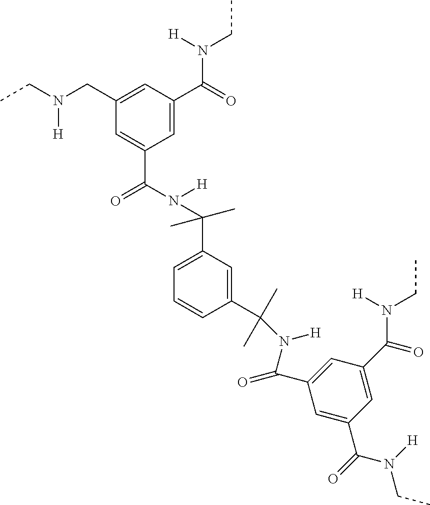

An additional embodiment is a composition or membrane containing a composition with a mixture of said aromatic monomers that have the nitrogen atom on the amino group separated by at least two sigma bonds from the benzene ring system and one or more acid chlorides selected from the group consisting of trimesoyl chloride (TMC), monotluorotrimesoyl (MFTMC), perfluorotrimesoyl chloride (PFTMC), nitrotrimesoyl chloride (NTMC), perchlorotrimesoyl chloride (PCTMC), 1,3,5-benzenetri-(difluoroacetoyl chloride), isophthaloyl chloride or mixtures thereof.

In the examples that follow, a new class of polyamides and polyamide membranes is exemplified showing chlorine resistant. It will be appreciated that chlorine resistant PA amides, polymers (linear, cross-linked, high and low molecular weight) should find a wide range of application in industry. Application could include linear and highly cross-linked polyamide polymers for the production of pipes, tanks and the like, fibers in clothing, chemically resistant coatings, flame retardant materials (due to the halogen groups), and chlorine resistant surfactants. Further, even in the area of membranes there is more than RO, and filtering processes such as microfiltration (MF), Nanofiltration (NF), and ultrafiltration (UF) could all benefit from PA polymers having improved chlorine resistance.

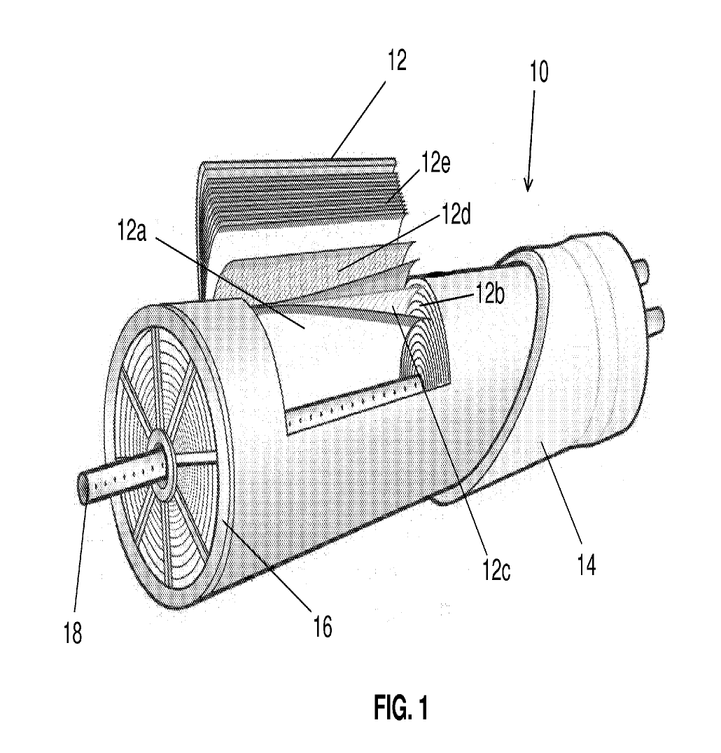

Although the invention has many different applications as discussed above, one important application is in the manufacture of reverse osmosis (RO) membranes. Referring to FIG. 1, a spiral wound RO membrane unit 10 is shown which is typical of those currently used in desalting plants. Unit 10 includes a membrane element 12 which is constructed in accordance with the present invention. Because element 10 is conventional apart from membrane 12 and moreover, the appearance of membrane 12 would not be different for a conventional membrane, unit 10 will be only briefly described below by way of background. It will also be understood that membranes made by the methods of the present invention can be used in different membrane units than that shown in FIG. 1.

Unit 10 includes an outer pressure vessel 14 typically made of fiberglass with an anti-telescoping device or shell 16 at opposite ends thereof. An axially extending product tube 18 is located centrally of element 10, as shown. The membrane element 12 itself includes a salt rejecting membrane surface 12a which forms part of a membrane leaf 12b including a tricot spacer 12c, a mesh spacer 12d, and a membrane 12e. It will be appreciated that the membrane element 12 is the key component of unit 10 and defines the actual surface where salt is separated from water. In embodiments of the present invention, the membrane is made from the chlorine resistant polyamide of the present invention.

As described above, one aspect of the present invention is modifying polyamide polymers so they exhibit chemical stability in chlorine water environments at a pH range of approximately 7 to approximately 10.5. Because of the difficulty in obtaining chemical data from polymers, especially highly-cross linked polymer systems, the examples will show synthesis of amides which are then exposed to high concentrations of chlorinated water. These amides are smaller units; polyamides are composed of many amide units. However, the chemical principles, as discussed above, of these amides that have been found apply directly to polyamide polymers.

The following examples are offered to illustrate, but not to limit the invention and use chlorine resistance as a model for halogen resistance.

### Example 1

1,3-bis (benzoylamino methyl)benzene, referred to as Amide A (using the amine MXD), was synthesized using the corresponding amine and the anhydride, benzoic anhydride. The final product was recrystallized in acetone-water.

The structure for this amide is:

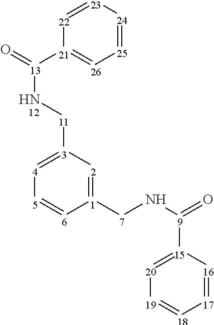

The following NMR data supports the successful synthesis of this new amide based on chemical shift arguments, number of major resonances, relative integral values and using a chemical shift prediction program:

¹HNMR (500 MHz, DMSO-d6): δ 9.04 (t, J=6.0 Hz, 2H), 7.87 (d, J=7.0 Hz, 4H), 7.53 (t, J=7.0, 2H), 7.45 (m, 4H), 7.28 (m, 2H), 7.20 (m, 2H), 4.47 (d, J=6.0 Hz, 4H); ¹³C NMR (125 MHz, DMSO-d6) δ 166.0, 139.6, 134.2, 131.1, 128.1, 127.1, 125.7, 125.5, 42.4.

### Example 2

1,3-bis(benzoylamino)benzene, referred to as Amide B (using the amine, MPD), was synthesized as described in Example 1 and the structure for this amide is below:

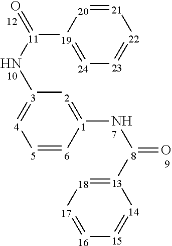

The following proton and carbon NMR data supports the successful synthesis of this new amide based on chemical shift arguments, number of major resonances, relative integral values, and using a chemical shift prediction program: ¹HNMR (500 MHz, DMSO-d6): δ 10.3 (s, 2H), 8.35 (s, 1H), 7.99 (d, J=7.5 Hz, 4H), 7.59 (m, 2H), 7.50-7.56 (m, 6H), 7.32 (t, J=8 Hz, 1H); ¹³C NMR (125 MHz, DMSO-d6): S 165.4, 139.3, 134.9, 131.5, 128.5, 128.3, 127.6, 116.0, 112.9.

### Example 3

The Amides Prepared in Examples 1 and 2 were Halogenated at pH 5.5 and 8 with phosphate buffers using chlorine exposure at approximately 660,000 ppm-hr. This would correspond to a reverse osmosis desalting plant operating at approximately 1 ppm Av. Cl₂ for over 75 years. This was in far excess of any expected membrane life of approximately 7-9 years. In addition, the three day exposure at approximately 9170 mg/L chlorine contained an added approximately 1,000 mg/L bromide ion. The bromide oxidizes in the free chlorine solution and was included because the feed water at the testing site contains bromide ion at a concentration of approximately 0.2 mg/L. Results presented in Table 1 below.

Amide A does not halogenate at pH 8.0. Although there is some chlorination at pH 5.5 for Amide A there is significant chlorination at pH 8.0 and pH 5.5 for Amide B. Table 1 lists only some of the masses of the halogenated compounds but a check of other masses show the bromo forms (mono, di, and tri) and chloro and bromo combinations exist for Amide A at pH 5.5 and for Amide B at pH 8.0 and 5.5. An example, not included in the table, is the mass at 583 which is C₂₀H₁₁N₂O₂Cl₃Br₂.

TABLE 1
Liquid Chromatography - Mass Spectrometry
(LC-MS) for Amide A and Amide B

| | | Retention | Observed | | |
|---|---|---|---|---|---|
| | | Time | Mass | % Abundance | Molecular |
| Amide | pH | (min) | (Da) | In Spectrum | Formula |
| A | 8.0 | 9.29* | 344.3 | 94.5 | C₂₂H₂₀N₂O₂ |
| A | 5.5 | 9.28 | 344.3 | 90.6 | C₂₂H₂₀N₂O₂ |
| A | 5.5 | 10.36 | 378.3 | 82.6 | C₂₂H₁₉N₂O₂Cl |
| A | 5.5 | 11.89 | 412.2 | 50.81 | C₂₂H₁₈N₂O₂Cl₂ |
| A | 5.5 | 13.69 | 446.2 | 24.25 | C₂₂H₁₇N₂O₂Cl₃ |
| B | 8.0 | 10.30 | 316.4 | 81.0 | C₂₀H₁₆N₂O₂ |
| B | 8.0 | 11.75 | 350.8 | 86.7 | C₂₀H₁₅N₂O₂Cl |
| B | 8.0 | 12.49 | 385.2 | 38.0 | C₂₀H₁₄N₂O₂Cl₂ |
| B | 8.0 | 12.49 | 419.7 | 4.87 | C₂₀H₁₃N₂O₂Cl₃ |
| B | 5.5 | 13.43 | 316.4 | 3.38 | C₂₀H₁₆N₂O₂ |
| B | 5.5 | 11.71 | 350.8 | 26.0 | C₂₀H₁₅N₂O₂Cl |
| B | 5.5 | 12.58 | 385.2 | 71.9 | C₂₀H₁₄N₂O₂Cl₂ |
| B | 5.5 | 10.78 | 419.7 | 34.9 | C₂₀H₁₃N₂O₂Cl₃ |

Molecular formulas derived from monoisotopic mass
*single peak for sample

In addition, for amide A at pH 5.5 and amide B, a check of other masses show the bromo forms (mono, di, and tri) and chloro and bromo combinations such as the mass at 583 which is C₂₀H₁₁N₂O₂CbBr₂. Further evidence of degradation of amide A at the undesirable pH of 5.5 and degradation of amide B.

### Example 3b

### Studies to Demonstrate Chlorine Resistance of Amides Based on New Chemical Principle

We have synthesized the following amides as model compounds to provide chemical data regarding our approach to chlorine resistance:

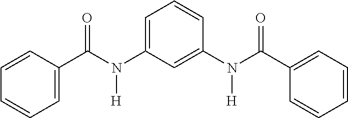 [SMILES: O=C(Nc1cccc(NC(=O)c2ccccc2)c1)c1ccccc1]

Amide A1—This amide would be similar to the meta-phenylene diamine (MPD) based desalting membrane of industry. This is made with the acid chloride TMC.

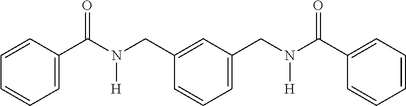 [SMILES: O=C(NCc1cccc(CNC(=O)c2ccccc2)c1)c1ccccc1]

Amide A2—This amide would be similar to the meta-xylene diamine (MXDA) based membrane used in our recent patent application. This is a MXDA-TMC membrane system.

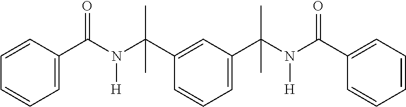 [SMILES: CC(C)(NC(=O)c1ccccc1)c1cccc(C(C)(C)NC(=O)c2ccccc2)c1]

Amide A3—This amide would be similar to a membrane made with our 1,3-tetramethylxylylene diamine (TMMXDA) and would be a TMMXDA-TMC membrane system.

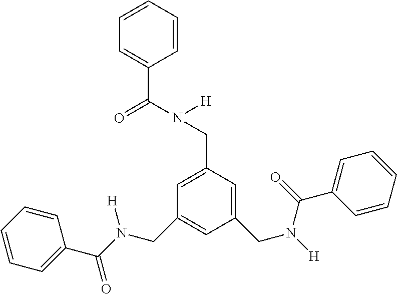 [SMILES: O=C(NCc1cc(CNC(=O)c2ccccc2)cc(CNC(=O)c2ccccc2)c1)c1ccccc1]

Amide A4—This amide would be similar to a membrane made with 1,3,5-tris(Aminomethyl)benzene (TAMB) and would be a TAMB-TMC membrane system.

TABLE 2
Data supporting synthesis of amides described above:

| | | Calculated | Molecular Ion from |
|---|---|---|---|
| | | Molecular | Mass |
| Sample No. | Empirical Formula | Weight | Spectrometry(MS) |
| A1 | C₂₀H₁₆N₂O₂ | 316 | 316 |
| A2 | C₂₂H₂₀N₂O₂ | 344 | 344 |
| A3 | C₂₆H₂₈N₂O₂ | 400 | 400 |
| A4 | C₃₀H₂₇N₃O₃ | 477 | 477 |

The MS data confirms the successful syntheses of the above four amides. The unique RT and molecular ion for each amide makes it possible to quantitate for each amide in the study.

### Example 3c

### Data Using A4 and a Summary of LC/MS on Model Amides

LC peaks are presented that show the superiority of our invention based on the discovery of a two sigma bond distance from the aromatic ring to generate a class of chlorine resistant monomers. These halogenation experiments followed conditions in Example 12 above.

TABLE 3
% Amide Survival

| Sample | Targeted | | | Retention | % Amide |
|---|---|---|---|---|---|
| Amide | Mass | Observed? | pH | Time (min) | Surviving |
| A1 | 316 | Yes | Starting | 8.19 | 100 |
| | | | cmpd | | |
| A1 | 316 | Yes | 5.5 | 8.19 | 66 |
| A1 | 316 | Yes | 8.5 | 8.21 | 50 |
| A2 | 344 | Yes | Starting | 7.47 | 100 |
| | | | cmpd | | |
| A2 | 344 | Yes | 5.5 | 7.46 | 98 |
| A2 | 344 | Yes | 8.5 | 7.47 | 93 |
| A3 | 400 | Yes | Starting | 8.94 | 100 |
| | | | cmpd | | |
| A3 | 400 | Yes | 5.5 | 8.94 | 100 |
| A3 | 400 | Yes | 8.5 | 8.94 | 100 |
| A4 | 477 | Yes | Starting | 7.15 | 100 |
| | | | cmpd | | |
| A4 | 477 | Yes | 5.5 | 7.15 | 85 |
| A4 | 477 | Yes | 8.5 | 7.18 | 99 |

% Amide Surviving=A/B×100

### Where,

A=LC/PDA Area % of the halogenated sample
B=LC/PDA Area % of the recrystallized starting product

At pH 5.5 and 8.5, samples A1 (1 sigma distance from ring), show 66 and 50% survival of the original amide. The other three amides show superior resistance to chlorine degradation.

In these halogenation studies the amides remain as insoluble particles. A1's deterioration may be diffusion-limited and may explain why there is any remaining amide left. If the amine (MPD) for this amide was used to make the cross-linked thin film (such as the commercially successful TMC-MPD membrane) there would likely be no thin film left.

### Example 3d

### Data Using A4 and a Summary of Halogenated Products

The follow data show four chlorination products from the halogenation experiments in Example 3. Note that in additional to these, for A1, there are a number of chloro and bromo-amides formed and combinations of both such as C20HuNu02CbBr2 with a molecular weight of 583 as mentioned in Example 3. Polyamides made with the amine used in A1 (MPD) degrade and in the process can produce multiple halogenated by-products.

TABLE 4
Halogenated Amide Products (Yes/No)

| Sample | | | | | |
|---|---|---|---|---|---|
| Amide | pH | Monochloro | Dichloro | Trichloro | Tetrachloro |
| A1 | 5.5 | Yes | Yes | Yes | Yes |
| A1 | 8.5 | Yes | Yes | Yes | Yes |
| A2 | 5.5 | No | No | No | No |
| A2 | 8.5 | No | No | No | No |
| A3 | 5.5 | No | No | No | No |
| A3 | 8.5 | No | No | No | No |
| A4 | 5.5 | Yes | Yes | Yes | Yes |
| A4 | 8.5 | No | No | No | No |

Table 3 and 4 are further data in support of our claim on how to modify or select the amine monomers to produce a chlorine resistant polyamide.

### Example 4

The following two polymers were synthesized using the amines MXD and MPD, and the acid chloride isothaloyl chloride for halogenations experiments on linear polymers.

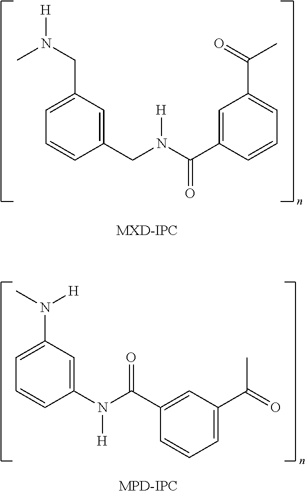

As can be seen from the structures, these polymers have the amide linkages of Amide A and Amide B and because these are polymers, they represent a closer extrapolation to the cross-linked polymers used for membranes.

The amides were halogenated at pH approximately 5.5 and approximately 8 with phosphates buffers using chlorine exposure of approximately 228,000 ppm-hr. This would correspond to a reverse osmosis desalting plant operating at approximately 1 ppm Av. Cl₂ for over 26 years. This was in far excess of any expected membrane life of approximately 7-9 years.

On these polymer samples, elemental analyses were performed for total chlorine. The Table 2 below presents the data at pH approximately 8.0. The data suggests that the linear MXD-IPC polymer (containing Amide A) at pH approximately 8.0 has considerably less chlorine atom per monomer unit (approximately 0.27) suggesting that there is only some chlorine addition. This data might represent chlorination of the unreacted end groups of the linear polymer or experimental error-perhaps incomplete washing of chloride ion from the polymer samples. Because of the LC-MS data on amide A at this pH failed to show any evidence of chlorination, it seems unlikely that N-chlorination, amide nitrogen chlorination, or ring chlorination occurred with this linear polymer. The MPD-IPC polymer (containing Amide B) polymer has greater than 1 chlorine atom per monomer unit (approximately 1.07) which suggests N-chlorination which could have advanced to ring chlorination and ultimately serious polymer chlorine degradation. LC-MS data on amide B at this pH show serious halogenations in support of elemental analysis. The MXD-IPC (amide A) polymer is superior in chlorine resistance to the MPD-IPC (amide B). This suggests that a membrane made with MXD would be chlorine resistant.

TABLE 5
Percent Addition of Chlorine to Linear Polymers at pH 8

| | | | | | Final | Mole |
|---|---|---|---|---|---|---|
| | | | Chlorine | | Chlorine | Cl/ |
| | | Condi- | Exposure | Chlorine | % | monomer |
| Polymer | pH | tions | ppm-hrs | % w/w | w/w | unit* |
| MXD-IPC | 8.0 | control | 0 | 0.73 | | |
| MXD-IPC | 8.0 | residue | 228,000 | 4.29 | 3.56 | 0.27 |
| MPD-IPC | 8.0 | control | 0 | 0.68 | | |
| MPD-IPC | 8.0 | residue | 228,000 | 16.62 | 15.9 | 1.07 |

*266 Da for MXD-IPC and 238 Da for MPD-ICP

As seen in Table 6, at pH approximately 5.5, the linear MXD-IPC polymer (Amide A) has a greater chlorine atom per monomer unit (approximately 0.80) than the same polymer at pH approximately 8.0. The MPD-IPC polymer (Amide 13) has a greater than one chlorine atom per monomer unit (approximately 1.65) which suggests more damage possibly N-chlorination and ring chlorination. The MXD-IPC polymer is superior to the MPD-IPC polymer at pH approximately 5.5. The MXD-IPC is superior in chlorine resistance to the MPD-IPC at pH approximately 5.5.

Because the feed water at RO desalination plants operate near pH approximately 8.0 and not pH approximately 5.5, the best results from these tables can be appreciated and membranes made with the MXD amine operated at near pH approximately 8.0 should demonstrate superior chlorine resistance properties compared to the existing commercial membranes made with MPD.

TABLE 6
Percent Addition of Chlorine to Linear Polymers at pH 5.5

| | | | | | Final | Mole |
|---|---|---|---|---|---|---|
| | | | Chlorine | | Chlorine | Cl/ |
| | | Condi- | Exposure | Chlorine | % | monomer |
| Polymer | pH | tions | ppm-hrs | % w/w | w/w | unit* |
| MXD-IPC | 5.5 | control | 0 | 0.73 | | |
| MXD-IPC | 5.5 | residue | 228,000 | 11.41 | 10.7 | 0.80 |
| MPD-IPC | 5.5 | control | 0 | 0.68 | | |
| MPD-IPC | 5.5 | residue | 228,000 | 25.31 | 24.6 | 1.65 |

*266 Da for MXD-IPC and 238 Da for MPD-ICP

In addition, for amide A at pH 5.5 and amide B, a check of other masses show the bromo forms (mono, di, and tri) and chloro and bromo combinations such as the mass at 583 which is C20HInN202CbBr2. This is further data supporting degradation of amide B and of amide A at the undesirable pH of 5.5.

### Example 5

This example shows halogenations of the amide and resonances that result from mixtures of halogenated compounds at a buffered pH of approximately 5.5 on Amide B using the conditions described above in Example 3. The NMR data show a distribution of resonances that result from mixtures of halogenated compounds at a buffered pH of approximately 8.0 on Amide B (using the amine MPD. The following show one example of the ¹H NMR and 13 C NMR data at pH approximately 8.0: ¹H NMR (500 MHz, DMSO-d6): δ 10.48 (s, 0.4H), 10.32 (s, 1.2H), 8.31-8.35 (m, 0.7H), 8.10-8.14 (m, 0.51-1H), 7.95-8.02 (m, 5.11-1), 7.73-7.78 (m, 0.6-1), 7.47-7.63 (m, 10.0H), 7.30 (t, J=8.0 Hz, 0.8H); ¹³C NMR (125 MHz, DMSO-d6): δ 165.7, 165.5, 139.4, 139.2, 138.5, 134.9, 134.6, 133.8, 131.9, 131.7, 131.5, 139.3, 128.5, 128.3, 127.7, 123.7, 119.2, 119.8, 119.2, 116.1, 113.0, 112.9.

Note: integer integrals cannot be reported since the NMR spectrum represents a mixture of substances. Only resonances for the most major peaks are reported in the proton data along with relative ratios for proton integrals. Only the most prominent peaks are reported for ¹³C data.

The following data show a distribution of resonances that result from mixtures of halogenated compounds at a buffered pH of approximately 5.5 on Amide B. The following show one example of the ¹H NMR and ¹³C NMR at pH approximately 5.5: ¹H NMR (500 MHz, DMSO-d6): δ 10.48 (s, 5.0H), 10.40 (s, 0.4H), 10.32 (s, 2.5H), 10.22 (s, 0.7H), 8.32-8.35 (m, 1.3H), 8.09 (s, 0.6H), 7.95-8.04 (m, 23.6H), 7.83-7.90 (m, 2.2H), 7.48-7.64 (m, 37.2), 7.41-7.45 (m, 1.2H), 7.30 (t, J=8.0 Hz, 1.4H); ¹³C NMR (125 MHz, DMSO-d6): δ 165.6, 165.3, 139.4, 135.5, 134.9, 133.4, 133.1, 132.2, 131.6, 128.6, 128.4, 128.2, 128.1, 127.8, 127.5, 116.2, 113.

The above data at pH approximately 8 and approximately 5.5, based on both ¹H NMR and ¹³C NMR, show N-halogenation of Amide B as follows:

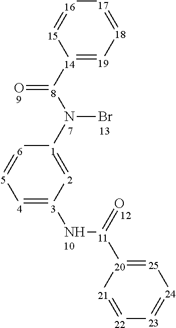

and these data at pH approximately 8 and approximately 5.5, based on both ¹H NMR and 13C NMR, show ring halogenations of Amide B as follows:

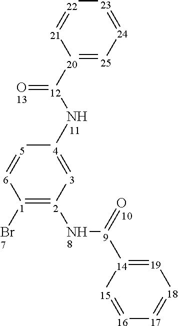

These data show that at carbon 1, halogenation occurs and carbon 3 is less likely to halogenate due to sterics.

### Example 6

This example describes a polyamide reverse osmosis composite membrane is formed on the surface of a porous polysulfone supporting membrane by a polycondensation reaction at the interface between an aqueous solution of m-xylylenediamine and a hydrocarbon solvent containing trimesoyl chloride. After the reaction is complete, the membrane is partially dried, rinsed and finally fully dried.

In a reverse osmosis test, the membranes were flushed with DI water at an applied pressure of 400psi for four hours. Then, the feed was changed to 0.2 wt-% sodium chloride and permeate collected after four hours of operation. The three membrane samples exhibited the following water flux and sodium chloride rejection.

TABLE 7
Transport Properties

| Membrane | Flux (gal/ft2/day) | Salt Rejection (%) |
|---|---|---|
| 1 | 2.29 | 85.0 |
| 2 | 1.2 | 97.7 |
| 3 | 0.87 | 75.5 |

All of these three membranes along with an industry polyamide reverse osmosis membrane were exposed to a 500 ppm NaOCl solution at a pH of 8.5 for a different amount of hours to conclude if the membranes were chlorine resistant. The amounts of hours of exposure for hour tests were 21,000 ppm-hrs, 42.00 ppm-hrs, and 66,000 ppm-hrs. The industry polyamide reverse osmosis control membrane was exposed to the minimum 21,000 ppm-hrs of exposure since it is expressed in open literature that these membranes should not be exposed to more than 3,600 ppm-hrs of chlorine exposure. The control was tested before exposing it to our chlorine tests to obtain its flux and salt rejection before exposure and those numbers were of 11.73 gfd and 99.2% respectively.

Table 8 provides the transport properties after chlorine exposure and clearly shows the control industry polyamide membrane degraded from the exposure and therefore not chlorine resistant and all three of our new TMC/MXD membranes resulted in almost the same flux and salt rejection properties as seen before chlorination with only minor changes.

TABLE 8
Transport Properties After Chlorination

| Membrane | Flux (gal/ft 2/day) | Salt Rejection (%) | Flux % Change |
|---|---|---|---|
| Control | 27.65 | 93.7% | 136% |
| 1 | 1.97 | 85.1% | 14% |
| 2 | 1.18 | 95.4% | 2% |
| 3 | 0.81 | 74.6% | 7% |

The foregoing detailed description is for the purpose of illustration. Such detail is solely for that purpose and those skilled in the art can make variations therein without departing from the spirit and scope of the invention.

### Example 7

### Halogenation Studies on Synthesized and Novel Cross-Linked Polyamides Demonstrating Chlorine Resistance

Cross-linked polyamide polymer was synthesized using three different amines and TMC. MPD-TMC is the cross-linked polymer system used in industry to make the thin film composite (TFC) that's in widespread use today. MXDA-TMC is the polymer system used in our previous patent application. TMMXDA-TMC is the polymer system that is based on our new diamine.

It is difficult to obtain chemical data from a cross-linked polymer system due to polymer insolubility. In the example that follows the response is 1.) whether or not the polymer remains after a three day exposure to high concentration chlorine in pH 8.5 buffered water and 2.) the formation of total organic halides (TOX).

### Chlorination of Cross-Linked Polyamide Polymers

Into a 400 mL beaker, add 3 grams of the free amine with 100 mL of DI water. Dissolve and filter any residue. Next, adjust the pH to 12.0. Filter and add 100 mL of 0.02% TMC in hexane. Mix and collect the polymer into the mesh container for halogenation studies.

In this example, 3 gram masses of the above cross-linked polymers are placed in a fine mesh polypropylene screened containers where the samples are cycled into chlorinated water made at the same concentration as in Example 8 without any addition of bromide ion for one minute and cycled out to drip dry for one minute. This procedure was done on our automated instrument for 3 days which represents 228,000 ppm-hr. chlorine exposure.

TABLE 9
Immersion Tests for Chlorine Resistance
of Cross-linked Polyamide Polymer

| | Day 1 | Day 1 | Day 3 | Day 3 |
|---|---|---|---|---|
| | Total | Polymer | Total | Polymer |
| Sample | Cycles | Remains? | Cycles | Remains? |
| MPD-TMC | 1440 | Yes | 4320 | No |
| MXDA- | 1440 | Yes | 4320 | Yes |
| TMC | | | | |
| TMMXDA- | 1440 | Yes | 4320 | Yes |
| TMC | | | | |
| TAMB- | 1440 | Yes | 4320 | Yes |
| TMC | | | | |
| TOX* | | 817 | | 1680 |
| | | micrograms/L | | micrograms/L |

*TOX is Total Organic Halogen and these are measured in the chlorinated water used in the tests above. These are present in Day 1 and increase in concentration in Day 3. The MPD-TMC polymer system is degrading into smaller molecules that are present in the aqueous phase as chlorinated molecules (TOX). The other two systems demonstrate chlorine resistance.

### Example 8

### Formation of Thin Films Using MXDA and TMMXDA and TMC Demonstrating Increased Thin Film Strength

In the following example, experiments were designed to demonstrate that thin films can be produced with aqueous solutions of MXDA and TMMXDA and a hexane solution of TMC. These new films may result in superior membranes with improved transport properties and physical strength. Because both monomers with TMC result in improved chlorine resistance, there are advantages to combining these two amines. It would seem that reaction rates would be slower due to the sterics with TMMXDA compared to MXDA which is may be desirable. The following example demonstrates superior strength to the TMMXDA film by adding concentrations of MXDA.

This example does not provide quantitative data on these new formulations but simply demonstrates the beneficial effects of the addition MXDA to the final cross-linked polymer.

Improvements in Thin Film Strength:

In the following table, 10 mL of amine solutions were transferred to 20 mL glass vials (27 mm OD). Next, 10 mL of 0.02% TMC in hexane was added and a thin film at the interfaced was formed.

TABLE 10
Thin Film Penetration at 1.86 × 10³ Pa

| Sample No. | TMMXDA (%) | MXDA (%) | TMC (%) | Penetration |
|---|---|---|---|---|
| 1 | 2.0 | 0 | 0.02 | Yes |
| 2 | 1.5 | 0.5 | 0.02 | No |
| 3 | 1.0 | 1.0 | 0.02 | No |
| 4 | 0.5 | 1.5 | 0.02 | No |

Samples 2, 3, and 4 show superior strength compared to Sample 1.

### Example 9

### Synthesis of 1,3-Tertramethylxylylene Diamine Dihydrochloride Monohydrate

Examples 9-15 are chemical data in support of the new amine, 1,3-tetramethylxylylene diamine. This is a promising candidate to support our patent claims.

High Yield 1,3-Tertramethylxylylene Diamine Dihydrochloride Monohydrate from Tetramethyl-1,3-Xylylene Diisocyanate (m-TMXDI).

Into a 3000 mL glass reactor, add 100 g of tetramethyl-1,3-xylylene diisocyanate, 2000 mL 50/50 concentrated HCl and water. With stirring, increase temperature to 95° C. and maintain this temperature of 18 hrs. Afterwards, filter to remove any impurities, and cool to room temperature. Allow further crystallization in a freezer at 0° C. overnight. Filter and wash with cold 50/50 concentrated HCl and water.

Take a 100 mL subsample of the warm single phase solution prior to crystallization. Allow the sample to air dry overnight at room temperature and determine the constant mass next day.

Starting mass of diisocyanate=5 g

Final mass=5.8 g
Calculated mass of diamine dihydrochloride monohydrate=5 g diisocyanate×282.9 g/mole diamine dihydrochloride monohydrate I244
g/mole diisocyanate=5.8 g
% Yield=100×5.8 g/5.8 g=100
This example shows very high yield of product.

### Example 10

First Crystal Harvest of 1,3-tertramethylxylylene diamine dihydrochloride monohydrate from tetramethyl-1,3-xylylene diisocyanate with Different Initial Start Masses of the Diisocyanate.

Same conditions as in Example 1, except different starting masses.

TABLE 11
% Yield

| g of diisocyanate | g Final mass | % Yield |
|---|---|---|
| 100 | 77.9 | 67.1 |
| 100 | 87.9 | 75.9 |
| 50 | 36.5 | 62.9 |
| 75 | 66.6 | 76.5 |

Obviously, the supernatant has more diamine dihydrochloride monohydrate that can be recovered. Alternatively, as in Example 1, the water and HCl could be removed leaving a higher yield.

### Example 11

### Data in Support of 1,3-Tertramethylxylylene Diamine Dihydrochloride Monohydrate Based on the Empirical Formula of C₁₂H₂ON₂.2HCl.H₂O

TABLE 12
Empirical formula C12H20N2•2HC1•H2O

| | | Elemental |
|---|---|---|
| Percent | Theoretical | Analyses |
| C | 50.9 | 50.7 |
| H | 8.48 | 8.53 |
| N | 9.90 | 9.84 |
| Cl | 25.1 | 24.6 |
| O | 5.66 | 5.60 |
| Total | 100.0 | 99.3 |

The following table lists the % H₂O from the possible hydrates of the diamine dehydrate: Table 13—Possible Hydrates of the Empirical formula C₁₂H₂₀N₂.

TABLE 13
Possible Hydrates of the Empirical formula
C₁₂H₂₀N₂•2HC1•nH₂O

| Hydrate | Molecular Weight | % H20 |
|---|---|---|
| 0 | 264.9 | 0 |
| 1 | 282.9 | 6.36 |
| 2 | 300.9 | 12.0 |
| 3 | 318.9 | 16.9 |
| 4 | 336.9 | 21.4 |
| 5 | 354.9 | 25.4 |
| 6 | 372.9 | 29.0 |

In the next example, the % water in the sample determined by both Karl Fischer and weight loss dry air at 35° C.

### Example 12

### Data in Support of 1,3-Tertramethylxylylene Diamine Dihydrochloride Monohydrate Based on the Empirical Formula of C₁₂H₂₀N₂O.2HCl.H20

Subsamples from different batches of product synthesized over two weeks.

Data in Support of the Final Product After Crystallization is the

TABLE 14
Percentage of H₂O

| Batch No. | Karl Fischer Water | Weight Loss |
|---|---|---|
| 1 | 6.77 | 6.27 |
| 2 | 6.92 | 6.47 |
| 3 | 6.61 | 6.01 |
| 4 | 6.47 | 6.04 |
| 5 | 6.82 | 6.66 |
| 6 | 6.45 | 6.08 |
| Average | 6.67 | 6.26 |

These data support the monohydrate.

(1.) Synthesis of 1,3-Tertramethylxylylene Diamine:

The free base of the diamine dihydrochloride monohydrate was synthesized using the dimethyl carbonate, an environmentally attractive solvent.

### Example 13

### 1,3-Tertramethylxylylene Diamine Using Dimethyl Carbonate

In a 400 mL beaker, add 45 g of 1,3-tertramethylxylylene diamine dihydrochloride monohydrate and warm slightly. Adjust the pH to 12 with NaOH and extract into 300 mL of dimethyl carbonate (DMC). The DMC was removed using a rotovap at 70° C., partial vacuum and the final product was a liquid.

### Example 14

### Data in Support of the Empirical Formula of C₁₂H₂₀N₂

TABLE 15
Empirical formula C₁₂H₂₀N₂

| | | Elemental |
|---|---|---|
| Percent | Theoretical | Analyses |
| C | 75.0 | 74.3 |
| H | 10.4 | 10.4 |
| N | 14.6 | 14.4 |
| Total | 100.0 | 99.1 |

High resolution mass spectrometry of this sample identified the following: 193.1700 ([M+H]⁺) which calculates to the empirical formula:

C₁₂H₂₁N₂

which is the protonated form of our new amine. This confirms the elemental analyses for our new compound:

C₁₂H₂₀N₂

### Example 15

### Data in Support of the Chemical Structure of 1,3-Tertramethylxylylene Diamine

The chemical structure of the diamine can be seen below:

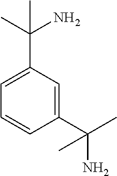

This was determined using high-resolution 1H and 13C and two-dimensional (2D) HSQC and HMBC NMR experiments. These confirm the proposed above diamine structure.

The NMR assignment is:

1H NMR (500 MHz, CD₂Cl₂): δ 7.73 (td, J ° 2.0 Hz, 1H), 7.37 (m, J=7.7 Hz, 2H), 7.27 (ddd, J=7.0 Hz, 1H), 1.48 (s, 12H); ¹³C NMR (125 MHz, CD2Cl₂) δ 150.8, 128.0, 122.8, 121.5, 52.7, 33.4.

What is claimed:

1. A halogen resistant amide polymeric composition comprising an amine-based aromatic monomer that has the nitrogen atom on the amino group separated by at least two sigma bonds from the benzene ring system.

2. The composition of claim 1, wherein the amine group of the aromatic monomer comprises the structure: 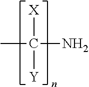
Where, n=1, 2, 3 or 4
X=—H, —CH₃, —C₂H₅, —C₃H₇, or —C₄H₉
Y=—H, —CH₃, —C₂H₅, —C₃H₇, or —C₄H₉.

2. The halogen resistant amide composition of claim 2 wherein the amine is meta-tetramethylxylylene diamine, tris (Aminomethyl)benzene (TAMB), or, meta-xylene diamine (MXDA).

3. The halogen resistant membrane of claim 3 consisting essentially of a mixture of claim 1 amine and one or more acid chlorides selected from the group consisting of trimesoyl chloride (TMC), monofluorotrimesoyl (MFTMC), perfluorotrimesoyl chloride (PFTMC), nitrotrimesoyl chloride (NTMC), perchlorotrimesoyl chloride (PCTMC), 1,3,5-benzenetri-(difluoroacetoyl chloride), and isophthaloyl chloride.

4. A halogen resistant membrane comprising an amine-based aromatic monomer as of claim 1.

5. The halogen resistant membrane of claim 4 wherein said amine monomer is meta-tetramethylxylylene diamine, tris (Aminomethyl)benzene (TAMB), or, meta-xylene diamine (MXDA).

6. The halogen resistant membrane of claim 5 consisting essentially of a mixture of meta-tetramethylxylylene diamine, tris (Aminomethyl)benzene (TAMB), or, meta-xylene diamine (MXDA) and one or more acid chlorides selected from the group consisting of trimesoyl chloride (TMC), monofluorotrimesoyl (MFTMC), perfluorotrimesoyl chloride (PFTMC), nitrotrimesoyl chloride (NTMC), perchlorotrimesoyl chloride (PCTMC), 1,3,5-benzenetri-(difluoroacetoyl chloride), and isophthaloyl chloride.
